(19) United States
(12) Patent Application Publication
(10) Pub. No.: US 2015/0348734 A1
(43) Pub. Date: Dec. 3, 2015

(54) AUTOMATIC CIRCUIT BREAKER WITH AUXILIARY SHORT CIRCUIT

(71) Applicant: PHOENIX CONTACT GMBH & CO. KG, Blomberg (DE)

(72) Inventors: Elmar Schaper, Lügde (DE); Lutz Heuer, Blomberg (DE); Detlev Schürgens, Blomberg (DE); Bernd Schulz, Steinheim (DE)

(21) Appl. No.: 14/652,722

(22) PCT Filed: Dec. 17, 2013
(86) PCT No.: PCT/EP2013/076971

§ 371 Date: Jun. 16, 2015

(30) Foreign Application Priority Data
Dec. 17, 2012 (DE) 10 2012 112 435.3

(51) Int. Cl. H01H 89/04; H01H 33/02; H01F 7/08; H01H 71/16

(52) U.S. Cl. CPC H01H 89/04; H01H 71/16; H01H 33/02; H01F 7/08

(57) ABSTRACT

The invention relates to an automatic circuit breaker (2) for protecting a phase (4, 5, 6), having an input terminal (7), an output terminal (8), a current path (12), which electrically conductively connects the input terminal (7) and the output terminal (8), a disconnection apparatus (13), which is arranged in the current path (12) and is configured to interrupt the current path when actuated, a discharge terminal (9), a discharge path (15), which is connected at one end thereof to the current path (12) between the disconnection apparatus (13) and the output terminal (8) and is connected at the other end thereof to the discharge terminal (9), a connection apparatus (16), which is arranged in the discharge path (15) and is configured to connect through the discharge path when actuated, and a monitoring device (14), which is configured to monitor the current in the current path (12) and, when an overcurrent is identified, to actuate the disconnection apparatus (13) and the connection apparatus (16), wherein the monitoring device (14) is configured to carry out permanent current monitoring and short-circuit current monitoring. The invention additionally relates to a circuit breaker arrangement (1) having a plurality of such automatic circuit breakers (2).

The present invention relates to an automatic circuit breaker for protecting a phase, having an input terminal, an output terminal, a current path, which electrically conductively connects the input terminal and the output terminal, a disconnection apparatus, which is arranged in the current path and is configured to interrupt the current path when actuated, and a monitoring device, which is configured to monitor the current in the current path and, when an overcurrent is identified, to actuate the disconnection apparatus. The invention also relates to a circuit breaker arrangement comprising a plurality of the above-specified automatic circuit breakers for use in a multi-phase supply line, wherein each phase is protected by an automatic circuit breaker.

In electric circuits electrical lines are protected against heating and short circuit by the use of safety devices, which for example interrupt the line in the event of the occurrence of a short circuit. Safety devices of this type can be configured as automatic circuit breakers or as safety fuses.

Such an automatic circuit breaker is connected via the input terminal thereof to a current source. The output terminal of said automatic circuit breaker is connected to the load, wherein the input terminal and the output terminal are connected via a current path. A disconnection apparatus is arranged in the current path and is configured to interrupt the current path when actuated. The disconnection apparatus is usually configured as a switch, more specifically as a break contact. This additionally has a monitoring device, which monitors the current in the current path. When an overcurrent is detected the disconnection apparatus is actuated by the monitoring device, such that the disconnection apparatus interrupts the current path. The automatic circuit breaker usually has an actuation element, which, with the actuation of the disconnection apparatus, is actuated such that the actuation of the disconnection apparatus is identifiable externally. The disconnection apparatus can additionally be actuated manually via the actuation element in order to cancel or bring about the interruption.

When the current path is interrupted, an arc is produced, such that the current in the current path is not interrupted directly. The current is only completely interrupted when the arc is quenched. Known automatic circuit breakers are therefore usually configured with arcing chambers, into which the arc runs and is quenched. The arc is divided in the arcing chamber by quenching plates and is interrupted.

From the occurrence of the arc, the resistance across the disconnection apparatus rises and the current decreases. The off time until the quenching of the arc in known automatic circuit breakers is at least 4 ms. During this period of time, however, damage or even destruction of the load connected to the output terminal of the automatic circuit breaker could occur.

In multi-phase systems each phase is protected by an automatic circuit breaker of this type.

In practice, the problem is often encountered that the permissible parameters of a downstream switching unit, for example a contactor or a motor switchgear, may be exceeded, and therefore automatic circuit breakers have to be selected that trip even at low currents. Alternatively or additionally the switchgears are overdimensioned, which is associated with increased costs and may lead to additional losses. This leads to a design conflict in applications with high peak currents, as may occur for example when starting motors. An individual dimensioning of the system is also necessary in each case.

In addition, although current-limiting switching elements known from the prior art can quickly switch off high short-circuit currents, they act too slowly in the case of increased permanent currents, such that excessively large currents can flow through the downstream loads and switchgears. A coordination between the automatic circuit breaker, the current supply and the load is thus additionally impaired.

In this regard a distinction is made, in accordance with IEC Standard 60947-4-1 within the scope of short-circuit protection, between two classification types, which describe the permissible level of damage of a device or a load in the event of overcurrents. In classification type 1, downstream devices, such as contactors or semiconductor switchgears, can be destroyed. In classification type 2, the downstream devices have to remain functional in principle. Whereas mechanical switchgears, such as contactors, are often assigned to classification type 2, semiconductor switchgears, for example for motors, usually meet the requirements of classification type 1.

Proceeding from the above-mentioned prior art, the object of the invention is therefore to specify an automatic circuit breaker and a circuit breaker arrangement of the above-mentioned type, which enable an improved protection of downstream loads and switchgears against overcurrents.

The object is achieved in accordance with the invention by the features of the independent claims. Advantageous embodiments of the invention are specified in the dependent claims.

In accordance with the invention an automatic circuit breaker for protecting a phase is thus specified, having an input terminal, an output terminal, a current path, which electrically conductively connects the input terminal and the output terminal, a disconnection apparatus, which is arranged in the current path and is configured to interrupt the current path when actuated, a discharge terminal, a discharge path, which is connected at one end thereof to the current path between the disconnection apparatus and the output terminal and is connected at the other end thereof to the discharge terminal, a connection apparatus, which is arranged in the discharge path and is configured to connect through the discharge path when actuated, and a monitoring device, which is configured to monitor the current in the current path and, when an overcurrent is identified, to actuate the disconnection apparatus and the connection apparatus, wherein the monitoring device is configured to carry out permanent current monitoring and short-circuit current monitoring.

In accordance with the invention a circuit breaker arrangement comprising a plurality of the above-specified automatic circuit breakers for use in a multi-phase supply line is additionally specified, wherein each phase is protected by an automatic circuit breaker, and the automatic circuit breakers are coupled to one another.

The basic concept of the present invention is thus to specify an automatic circuit breaker which, by means of the connection of permanent current and short circuit current, ensures a reliable protection of downstream loads against overcurrents, and of which the protective effect is particularly quick in that, as the disconnection apparatus switches, currents are discharged via the discharge terminal by arcs that occur. The automatic circuit breaker thus has two characteristics, on the one hand the line protection for protection against excessive permanent currents, which lie above a permissible, maximum permanent current, and on the other hand a short-circuit protection, in order to ensure a protection against excessively large peak currents. The currents as the disconnection apparatus switches can flow off via the discharge terminal following the switching of the connection device, and therefore the protective function of the automatic circuit breaker is already provided very quickly. Depending on the switching times of the connection device, times of approximately 0.2 ms can be achieved here, after which the load is substantially without current.

The monitoring device is preferably configured for the joint actuation of the disconnection device and the connection device. The disconnection device and the connection device are particularly preferably actuated simultaneously by the monitoring device.

The automatic circuit breaker can be connected via the input terminal thereof to a current supply and at the output terminal thereof to a load, which may have an electrical switching device. The discharge terminal is preferably connectable to a ground or a neutral, via which a current can flow off during the switching. The disconnection device is preferably configured as a break contact for interrupting the current path. The connection device is usually configured as a closer for connecting through the discharge path.

In multi-phase current supplies, each automatic circuit breaker is connected via the input terminal thereof to a phase of the current supply. The discharge terminals are preferably connectable to a ground or a PE conductor, via which the current can flow off during the switching. Alternatively, the discharge terminal can be connected to another phase or a synthetic neutral point.

In an advantageous embodiment of the invention the automatic circuit breaker is developed in such a way that the monitoring device has a bimetal switch for permanent current monitoring. The heat in the current path is thus measured in order to detect an excessive conduction current. The protective behaviour can be selected by the choice of the bimetal characteristics.

In an advantageous embodiment of the invention the automatic circuit breaker is developed in such a way that the monitoring device has a solenoid switch for short-circuit current monitoring. Accordingly, a magnetic instantaneous tripping can be provided as short-circuit protection for quick processes, i.e. rapidly occurring peak currents. The sensitivity of the short-circuit protection can be achieved via the property of the magnetic material. The temporal profile of the magnetic field corresponds to a hysteresis curve. A magnetic field is preferably generated by the overcurrent, such that an actuation can occur with the aid of a relay coil and armature.

In an advantageous embodiment of the invention the automatic circuit breaker is developed in such a way that the automatic circuit breaker has a coupling device, to which the disconnection apparatus and the connection apparatus are coupled for joint actuation, and the monitoring device is configured to actuate the disconnection apparatus and the connection apparatus via the coupling device. The monitoring device thus has to actuate only the coupling device, whereby the disconnection apparatus and the connection apparatus are actuated automatically. The coupling device can be configured arbitrarily in principle. By way of example, the coupling device may be and electrical or electronic coupling device. The coupling device is particularly preferably a mechanical coupling device. The coupling device is more preferably actuated by a relay.

In an advantageous embodiment of the invention the automatic circuit breaker is developed in such a way that the automatic circuit breaker has an actuation element, which, in the event of an actuation by the monitoring device, is actuated such that the actuation is identifiable externally. The actuation element is preferably connected to the coupling device.

In an advantageous embodiment of the invention the automatic circuit breaker is developed in such a way that the actuation element is configured to manually actuate the disconnection apparatus and the connection apparatus.

Accordingly, the automatic circuit breaker can be actuated manually in order to disconnect a downstream load from the current supply. The actuation element is preferably connected to the coupling device.

In an advantageous embodiment of the invention the circuit breaker arrangement is developed in such a way that the automatic circuit breakers are coupled to one another mechanically. By means of the mechanical coupling, the automatic circuit breakers can reciprocally transmit an actuation by the respective monitoring device thereof to the other automatic circuit breakers. The mechanical coupling is to be produced particularly reliably and easily.

In an advantageous embodiment of the invention the circuit breaker arrangement is developed in such a way that the automatic circuit breakers have an actuation element for a manual actuation of the disconnection apparatus and the connection apparatus, and the automatic circuit breakers are mechanically coupled to one another via a coupling element. The mechanical coupling is particularly reliable and enables a simple transfer of the actuation between the automatic circuit breakers. The coupling element is particularly preferably configured as a separate component part to be mounted on the actuation elements. The coupling of the automatic circuit breakers can thus be carried out in a versatile manner. In particular, available automatic circuit breakers can be coupled to one another readily, such that a circuit breaker arrangement can thus be formed at any time.

In an advantageous embodiment of the invention the circuit breaker arrangement is developed in such a way that the coupling element has a manual actuator for the manual actuation of the coupled automatic circuit breakers. The circuit breaker arrangement can thus also be actuated manually in accordance with the actuation of the automatic circuit breakers in order to disconnect the load from the current supply for all phases at the same time. The manual actuator for the manual actuation is preferably configured both for the joint disconnection of the current paths of the individual automatic circuit breakers and for the connection through of the current paths, in accordance with the function of the actuation element of the automatic circuit breaker. The manual actuator is particularly preferably configured in such a way that the actuation is identifiable externally.

In an advantageous embodiment of the invention the circuit breaker arrangement is configured as an integral device.

The invention will be explained in greater detail hereinafter with reference to the accompanying drawing, on the basis of preferred embodiments.

In the drawing

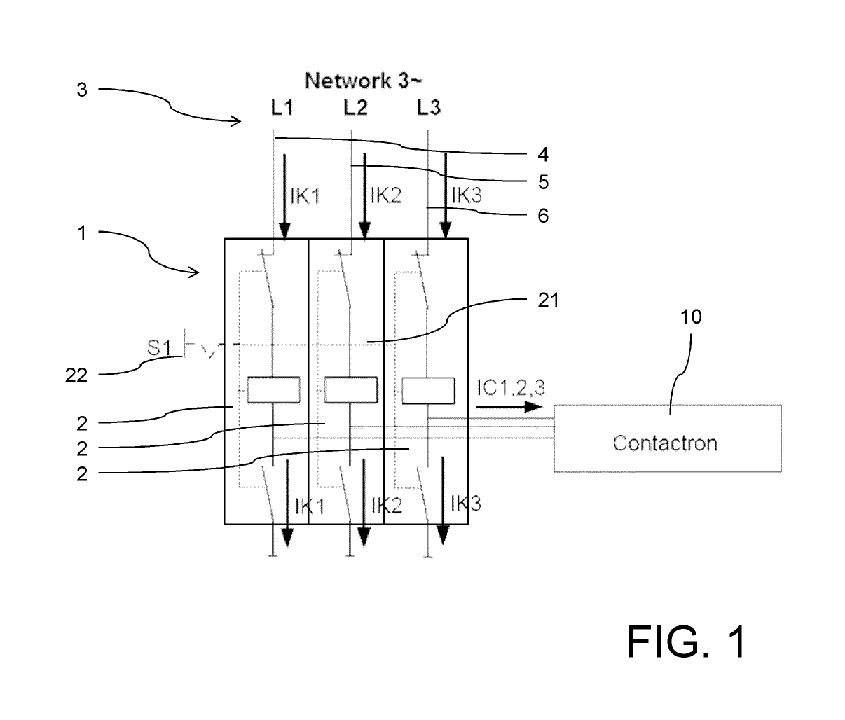

FIG. 1 shows a circuit diagram with a circuit breaker arrangement, which is arranged between a multi-phase current supply and a multi-phase load,

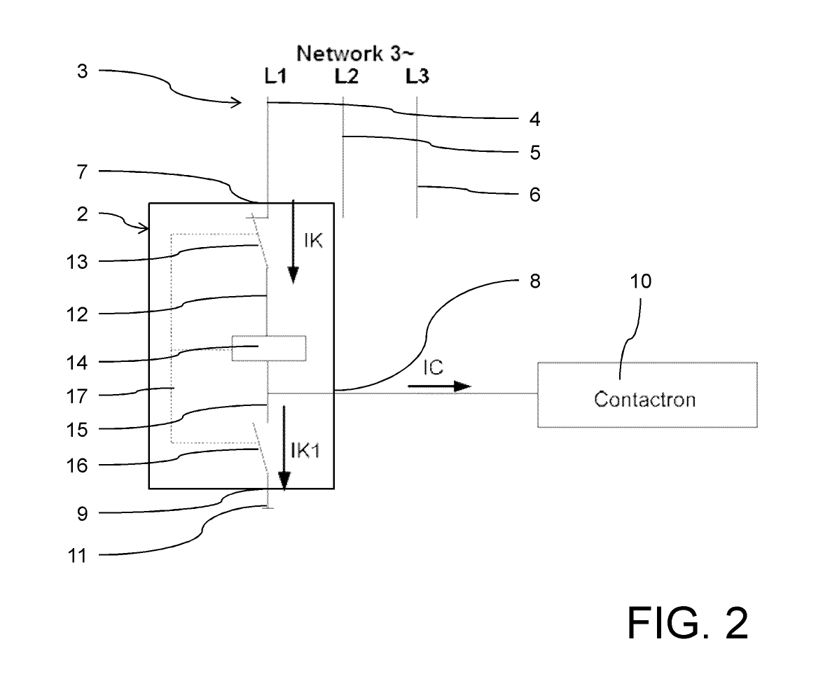

FIG. 2 shows a detailed view of the circuit diagram from FIG. 1, in which only one automatic circuit breaker of the circuit breaker arrangement is illustrated,

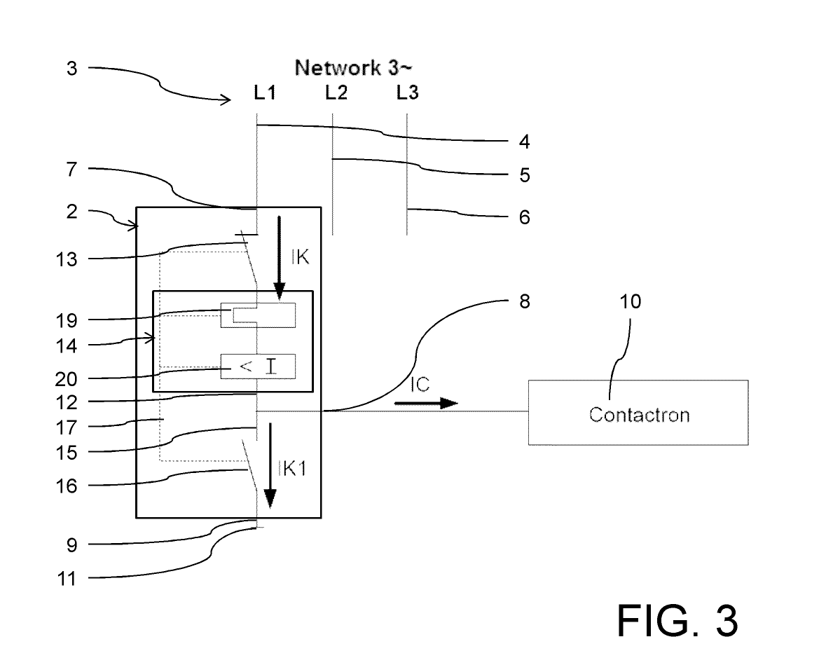

FIG. 3 shows a detailed view of the circuit diagram from FIG. 2, in which the automatic circuit breaker shown in FIG. 2 is illustrated in detail,

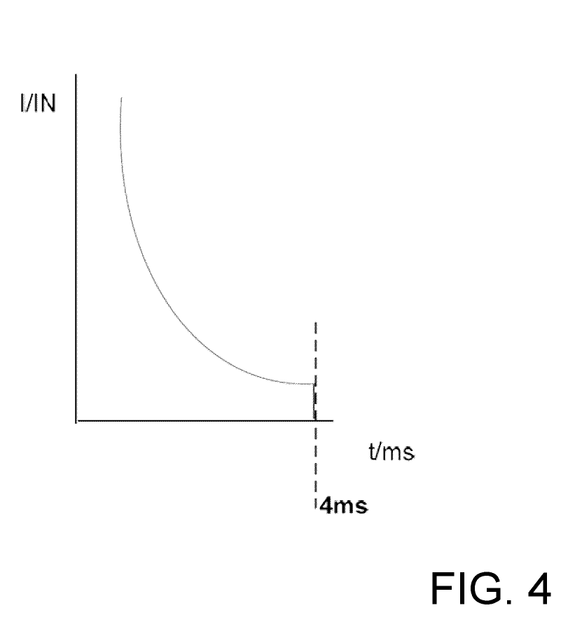

FIG. 4 shows a graph of a load current profile with use of a conventional automatic circuit breaker when measuring an overcurrent,

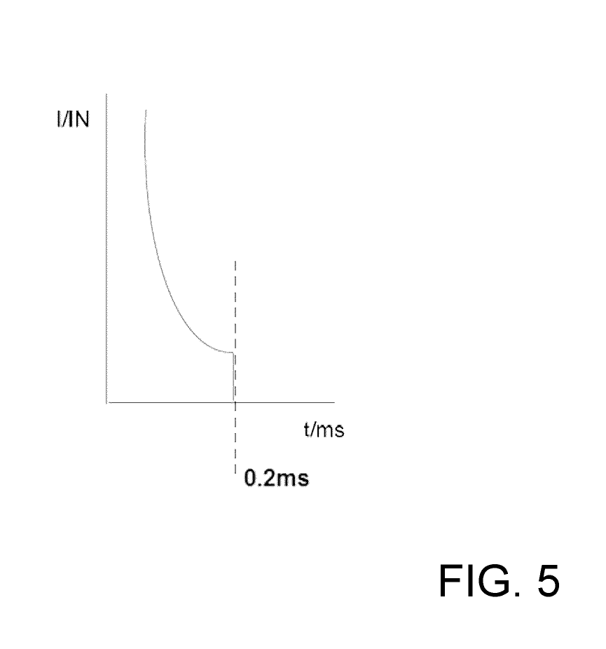

FIG. 5 shows a graph of a load current profile with use of an automatic circuit breaker according to the invention when measuring an overcurrent, and

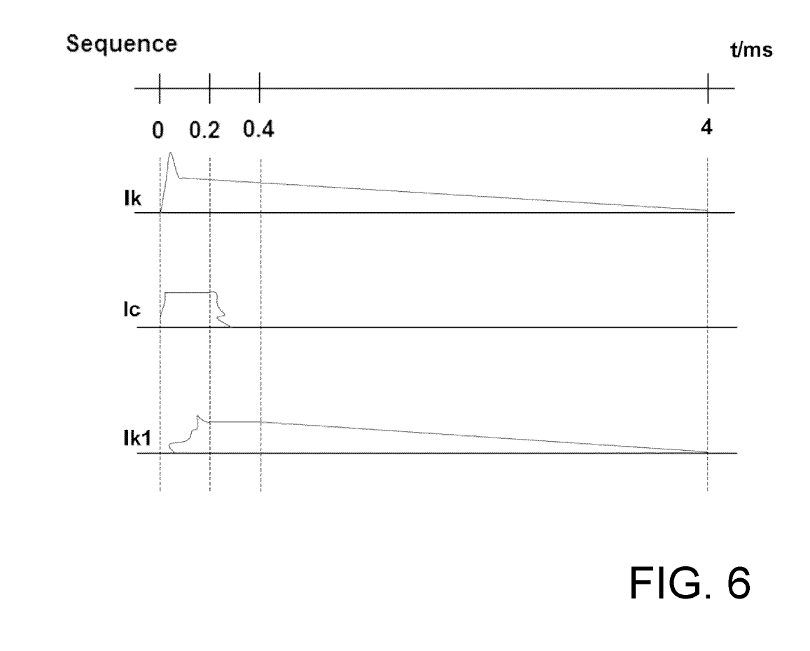

FIG. 6 shows a graph with the current profiles in the current path, in the discharge path and across the output terminal of the automatic circuit breaker.

FIGS. 1 to 3 show a circuit breaker arrangement 1 according to the invention comprising a plurality of automatic circuit breakers 2. The circuit breaker arrangement 1 is connected on the input side to a multi-phase current supply 3 or supply line, wherein each phase 4, 5, 6 is protected by an automatic circuit breaker 2.

Each automatic circuit breaker 2 is configured to protect a phase 4, 5, 6 and has an input terminal 7, an output terminal 8 and a discharge terminal 9. The automatic circuit breakers 2 are each connected via the input terminal 7 thereof to a phase 4, 5, 6 and via the output terminal 8 thereof to a load 10. The load 10 is a multi-phase load, which is illustrated here by way of example by an electronic switchgear. The discharge terminals 9 are each connected to a ground 11.

In the automatic circuit breaker 2, the input terminal 7 and the output terminal 8 are electrically conductively connected via a current path 12. A disconnection apparatus 13 and a monitoring device 14 are arranged in the current path 12. The disconnection apparatus 13 is configured as a break contact in order to interrupt the current path 12 when actuated. The monitoring device 14 is configured to monitor a current in the current path 12.

The automatic circuit breaker 2 additionally has a discharge path 15, which is connected at one end thereof to the current path 12 between the disconnection apparatus 13 and the output terminal 8 and also at the other end thereof to the discharge terminal 9. A connection apparatus 16 is arranged in the discharge path 15 and is configured to connect through the discharge path 15 when actuated. The connection apparatus 16 is configured as a closer, accordingly.

The disconnection apparatus 13 and the connection apparatus 16 are coupled to a coupling device 17 for joint actuation. The coupling device 17 in this exemplary embodiment is a mechanical coupling device 17. An actuation element, which is also actuated when the coupling device 17 is actuated, is connected to the coupling device 17, such that the actuation is identifiable externally, i.e. from outside the automatic circuit breaker (2). In addition a manual actuation of the coupling device 17 and therefore disconnection apparatus 13 and of the connection apparatus 16 can be performed by the actuation element.

The monitoring device 14 is configured, when an overcurrent is identified, to actuate the disconnection apparatus 13 and the connection apparatus 16 via the coupling device 17.

The monitoring device 14 has a bimetal switch 19 for permanent current monitoring in order to measure an excessive conduction current as overcurrent. In addition, the monitoring device 14 has a solenoid switch 20 with a magnetic instantaneous trip as short-circuit protection for quick processes for monitoring a short-circuit current as overcurrent. A magnetic field is generated in the solenoid switch 20 by the overcurrent, such that the coupling device 17 is actuated with the aid of a relay coil and armature.

FIGS. 4 and 5 schematically show the breakdown of the current Iₖ by the output terminal 8 for a conventional automatic circuit breaker and for an automatic circuit breaker 2 of the described exemplary embodiment. In the case of the conventional automatic circuit breaker, the current only falls to a safe value after approximately 4 ms, whereas this is the case already after approximately 0.2 ms with the automatic circuit breaker 2 described here.

FIG. 6 shows the efficacy of the automatic circuit breaker 2 in detail. A current I_{c}, which flows through the input terminal 7, is identified by the monitoring device 14 as overcurrent, whereby an actuation of the disconnection apparatus 13 and of the connection apparatus 16 via the coupling device 17 is triggered at the time t=0 s. Accordingly, the current path 12 is interrupted by the disconnection apparatus 13, and the discharge path 15 is connected through via the connection apparatus 16. The switching of the disconnection apparatus 13 and of the connection apparatus 16 in this exemplary embodiment lasts for approximately 0.2 ms. During this time the entire current I_{c} flows as output current Iₖ across the output terminal 8 and therefore across the load. At the time t=0.2 ms, the discharge path 15 is connected through, such that a current I_{c1} at the discharge terminal 9 is already approximately equal to the current I_{c} through the input terminal 7. Accordingly, the current Iₖ across the output terminal 8 breaks down and is already approximately zero at the time t=0.4 ms.

As can be seen in FIG. 1, the automatic circuit breakers 2 are mechanically coupled to one another via a coupling element 21. As a result of the mechanical coupling, the automatic circuit breakers 2 can transfer reciprocally an actuation by the respective monitoring device 14 thereof to the other automatic circuit breakers 2. The coupling element 21 in this exemplary embodiment is configured as a separate component part, which is connected to the actuation elements of the three automatic circuit breakers 2 in a manner not shown here in detail. The coupling element 21 is configured with a manual actuator 22 for the manual actuation of the coupled automatic circuit breakers 2. The manual actuator 22 for the manual actuation is configured both for the joint disconnection and connection through of the current paths 12, wherein the actuation is identifiable externally via the manual actuator 22.

In an alternative embodiment not illustrated here the circuit breaker arrangement 1 is configured as an integral device.

### LIST OF REFERENCE SIGNS

circuit breaker arrangement 1
automatic circuit breaker 2
current supply, supply line 3
phase 4
phase 5
phase 6
input terminal 7
output terminal 8
discharge terminal 9
load 10
mass 11
current path 12
disconnection apparatus 13
monitoring device 14
discharge path 15
connection apparatus 16
coupling device 17
bimetal switch 19
solenoid switch 20
coupling element 21
manual actuator 22

1. An automatic circuit breaker for protecting a phase, comprising:
an input terminal;
an output terminal;
a current path electrically connecting the input terminal and the output terminal;
a disconnection apparatus, which is arranged in the current path and is configured to interrupt the current path when actuated;
a discharge terminal;
a discharge path having a first end connected to the current path between the disconnection apparatus and the output terminal and a second end connected to the discharge terminal;
a connection apparatus arranged in the discharge path and configured to connect through the discharge path when actuated; and
a monitoring device configured to monitor a current flowing through the current path and, when an overcurrent is identified, to actuate the disconnection apparatus and the connection apparatus,
wherein the monitoring device is further configured to carry out permanent current monitoring and short-circuit current monitoring.

2. The automatic circuit breaker according to claim 1, wherein the monitoring device has a bimetal switch for permanent current monitoring.

3. The automatic circuit breaker according to claim 1, wherein the monitoring device has a solenoid switch for short-circuit current monitoring.

4. The automatic circuit breaker according to claim 1, further comprising a coupling device to which the disconnection apparatus and the connection apparatus are coupled for joint actuation, wherein the monitoring device is configured to actuate the disconnection apparatus and the connection apparatus via the coupling device.

5. The automatic circuit breaker according to claim 1, further comprising an actuation element configured to be actuated by the monitoring device and to be actuated such that the actuation is identifiable externally.

6. The automatic circuit breaker according to claim 5, wherein the actuation element is configured to carry out a manual actuation of the disconnection apparatus and of the connection apparatus.

7. A circuit breaker arrangement electrically connected to a multi-phase supply line, the circuit breaker arrangement comprising a plurality of automatic circuit breakers coupled to one another, wherein each of the circuit breakers is in accordance with claim 1 and is configured to protect a different one of a plurality of phases of the multi-phase supply line.

8. The circuit breaker arrangement according to claim 7, wherein the automatic circuit breakers are mechanically coupled to one another.

9. The circuit breaker arrangement according to claim 8,
wherein each of the automatic circuit breakers has an actuation element for a manual actuation of the disconnection apparatus and the connection apparatus, and
wherein the automatic circuit breakers are mechanically coupled to one another via a coupling element.

10. The circuit breaker arrangement according to claim 9, wherein the coupling element has a manual actuator for the manual actuation of the coupled automatic circuit breakers.

11. The circuit breaker arrangement according to claim 7, wherein the circuit breaker arrangement is configured as an integral device.
